(19) United States
(12) Patent Application Publication
(10) Pub. No.: US 2026/0213036 A1
(43) Pub. Date: Jul. 23, 2026

(54) METHOD AND SYSTEM FOR GUIDANCE FOR GEOMETRICAL AND OPTICAL MAGNIFICATION IN X-RAY MICROSCOPE

(71) Applicant: Carl Zeiss X-ray Microscopy, Inc., Dublin, CA (US)

(72) Inventors: Andrew Chu, San Jose, CA (US); Naomi Kotwal, Livermore, CA (US); Hauyee Chang, Concord, CA (US); Susan Candell, Lafayette, CA (US); Thomas Anthony Case, Walnut Creek, CA (US); Brian Smyth, San Francisco, CA (US); Justin Hanlon, Dublin, CA (US); Wayne Broderick, Pleasanton, CA (US)

(21) Appl. No.: 19/157,866

(22) PCT Filed: Feb. 27, 2024
(86) PCT No.: PCT/US2024/017372

§ 371 Date: Aug. 19, 2025

Related U.S. Application Data
(60) Provisional application No. 63/487,068, filed on Feb. 27, 2023.

(51) Int. Cl. G21K 7/00; G01N 23/04

(52) U.S. Cl. CPC G21K 7/00; G01N 23/04

(57) ABSTRACT

A user interface rendered on a display of a microscopy system comprises motion controls for moving the object stage subsystem, source subsystem, and detector subsystem and a simulation region showing a resolution curve and a throughput curve is generated by a zoom tool and displayed on the systems graphical user interface.

### RELATED APPLICATIONS

This application claims the benefit under 35 USC 119 (e) of U.S. Provisional Application No. 63/487,068, filed on Feb. 27, 2023, which is incorporated herein by reference in its entirety.

### BACKGROUND OF THE INVENTION

X-ray microscopy (XRM) is a powerful imaging technique for analyzing internal structure on the micro to nano scale. XRM systems provide high resolution images of samples, allowing for detailed study of their properties. XRM systems use a beam of x-rays to illuminate the samples, which is then imaged using a detector. The x-rays are then analyzed to produce an image or projection of the sample.

X-ray computed tomography (CT) is a non-destructive technique for inspecting and analyzing internal structures of samples. Tomographic volume data sets are reconstructed from a series of these projections via standard CT reconstruction algorithms, as the samples are scanned at different angles.

There are a number of different configurations for x-ray CT systems. In x-ray microscopy systems, because the x-ray sources and detectors are large and the samples or objects being scanned are typically small, the x-ray sources and detectors are largely fixed during acquisition, while the samples are rotated in the x-ray beam, in contrast to medical CT systems in which the patient is stationary and the sources and detector rotate around the patient.

X-ray microscopy systems are often arranged in a relatively simple projection geometry, in which the x-rays penetrate the sample, and the transmitted x-rays are collected by the detector. With this setup, the geometrical magnification of the system is:

$$M = \frac{{L}_{s} + {L}_{d}}{{L}_{s}} , \qquad ( 1 )$$

where, Lₛ is the source to sample distance and the L_{d} is the sample to detector distance.

Some systems also, or alternatively, provide optical magnification with an optical stage. Typically, the detection subsystem includes a camera detector, such as one based on a charge coupled devices (CCD) or CMOS. A magnification lens or objective lens system is provided in the optical stage for imaging the light from a scintillator onto the camera. The magnification for the entire imaging system is thus distributed between the projection x-ray stage and the optical stage. In the preferred embodiment, the magnification of the optical stage is often between 0.4 and 40 times. The magnification of the x-ray stage is often between 1 and 10 times.

### SUMMARY OF THE INVENTION

One of the biggest challenges in imaging, especially for systems that can employ both geometrical and optical magnification, is what system geometry and optical magnification is best for a given application and sample. Not only is the operating space of possible configurations large, the definition of “best” can vary by application with some applications desiring resolution while others prefer speed or overall scanning area/volume. Since there can be multiple combinations which can achieve a particular pixel size and desired field-of-view, how to visualize the trade-offs and optimize the settings is a major challenge.

For current systems, deciding the final geometric and optical magnification to use on a sample is an iterative process by moving to those settings and taking images to verify desired settings. So, each possible solution must be individually assessed to make this decision.

This invention concerns helping the user make these decisions by creating an intuitive and interactive interface to explore the possible solution space, along with optimized recommendations, without changing the system configuration to each of those settings. Geometric collision constraints with the sample can be accounted for and sub-optimal solutions can be ignored, thus reducing the operating space to a more manageable set and allowing users to focus on key trade-offs between resolution, throughput, and Field-of-View (FOV) when optimizing selections.

Without guidance, optimal scan settings are not easily achievable. User understanding of the effects of geometric constraints on solution space and trade-offs between resolution, throughput, and FOV are highly user dependent. Even very experienced users can arrive at sub-optimal settings, and the need to manually set-up and interrogate the operating space iteratively can be very time consuming and error prone.

Embodiments of the invention employ a zoom tool that simulates system geometrical and optical magnification changes, resulting in a faster and more optimized process to determine geometric and optical magnifications. In addition, it can be based on region of interest (ROI) locations 1) graphically drawn on overview images in the user interface or 2) by other means such as non-graphical entry (e.g. from a GUI edit box, or from a file or other data source), rather than having the system to go to the actual positions first. It also uses the sample envelope such as size and shape to limit the accessible range of parameters so the user can feel confident that the final set up will not result in system collisions. The overview images can be generated in any number of ways including from: a solid model of the system and VLC imaged sample geometry, a solid model of the sample, volumetric imaging of the sample, projection imaging of the sample, correlated imaging modalities, and/or volumetric imaging of the sample combined with segmentation for automated ROI definition.

The tool uses the ROI location and size of the sample to determine the field of view desired. Using simulations, it next determines the possible optical magnifications to use, given limitations on the geometrical magnification based on the size and shape of the sample and available stage travel. It will recommend one option to use if multiple choices are viable.

The zoom tool then uses the selected optical magnification, if any, known details about the objective response, other system performance metrics, typical exposure ranges, and typical total number of projections in a tomography to create simulated curves to describe both the resolution response and the total scan time response as a function of reachable FOV and/or pixel size. In addition, there are recommended angle ranges based on sample shape of the sample (flat vs not). After generating these curves, the simulated or calculated field of view and pixel size at the ROI location desired can be shown to the user. The user is also shown ‘Recommended ranges’ for best results at the current settings. E.g ‘Best Resolution Ranges’, and ‘Fastest Scan Ranges’.

The zoom tool uses knowledge that a sample is flat or box shaped to recommend more optimized acquisition parameters for selection in order to improve the image quality of the final tomography, such as:
variable-angle tomography with more projections through the longest sample dimension;
variable-exposure tomography with higher exposures on longest sample dimension; and
tomographies using 180+fan or limited-angles (less than 180+fan) where the angle range is optimized to keep the sample and even the ROI closest to the source for faster tomographies. Keeping the source as close as possible is an important optimization here. The sample can be close to the source for many angle ranges using less than 360 degrees, but it is the angle range that has the ROI closest to the source that is the optimal one for fastest tomographies.

Also it is possible to perform scans with limited-angles (less than 180+fan) where the projection data is incomplete but 3D volume data can be generated (with potentially acceptable artifacts). These optimization/visualization techniques might are also applied in some examples.

The user is allowed to change these settings, e.g., binning, angle range, and/or the initial objective selected, and the zoom tool illustrates the effects of the changes by generating new curves for those settings in the graphical user interface. For example, if the user switches to another optical magnification, new curves will be generated. Since changes may not be optimum for best results, the graphs may show that the current optical magnification is not recommended for this ROI.

When the user accepts a final result, the final ROI locations, optical and geometrical magnification and all other acquisition parameters can be saved to the actual tomography recipe point without the user having to take the time to move the system.

In general, according to one aspect, the invention features user interface rendered on a display of a microscopy system including a computer that processes projection data from the microscopy system. The user interface comprises motion controls for moving an object stage subsystem, a source subsystem, and a detector subsystem for configuring the microscopy system to the desired positions for imaging a region of interest of a sample and a simulation region showing a resolution curve and a throughput curve for imaging the region of interest of the sample.

Preferably, the simulation region further includes region of interest marker for showing the region of interest (ROI). And, this defined region of interest is often specified by graphically defining the region of interest on one or more overview images displayed in one or more panes of the user interface, wherein the overview images are derived from models of the system and/or a sample, volumetric imaging of the sample, projection imaging of the sample, correlated imaging modalities, and/or volumetric imaging of the sample combined with segmentation for automated ROI definition. The ROI, however, can also be specified by non-graphical entry (e.g. from a GUI edit box, or from a file or other data interface).

The resolution curve and the throughput curve can be constrained by sample geometry, stage travel, and collision constraints. Moreover, the resolution curve and the throughput curve are preferably updated in response to user changes to the field of view and pixel size and/or user changes to optical magnification.

In general, according to another aspect, the invention features an X-ray microscopy system comprising an X-ray source subsystem of generating X-rays, an object stage subsystem for holding a sample in the X-rays, a detector subsystem for detecting the X-rays after interaction with the sample and a computer for receiving projections from the detector subsystem. The computer additionally generates a user interface including motion controls for moving the object stage subsystem, a source subsystem, and a detector subsystem, and a simulation region showing a resolution curve and a throughput curve.

In general, according to another aspect, the invention features a method of operation of microscopy system including a computer that processes projection or image data from the microscopy system. This method comprises displaying motion controls for moving an object stage subsystem, a source subsystem, and a detector subsystem and displaying a simulation region showing a resolution curve and a throughput curve.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an x-ray microscopy system to which the present invention is applied in one embodiment;

FIGS. 2, 3, 4, 5, 6, 7, 8, 9, and 10 show a user interface generated by the x-ray microscopy system.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

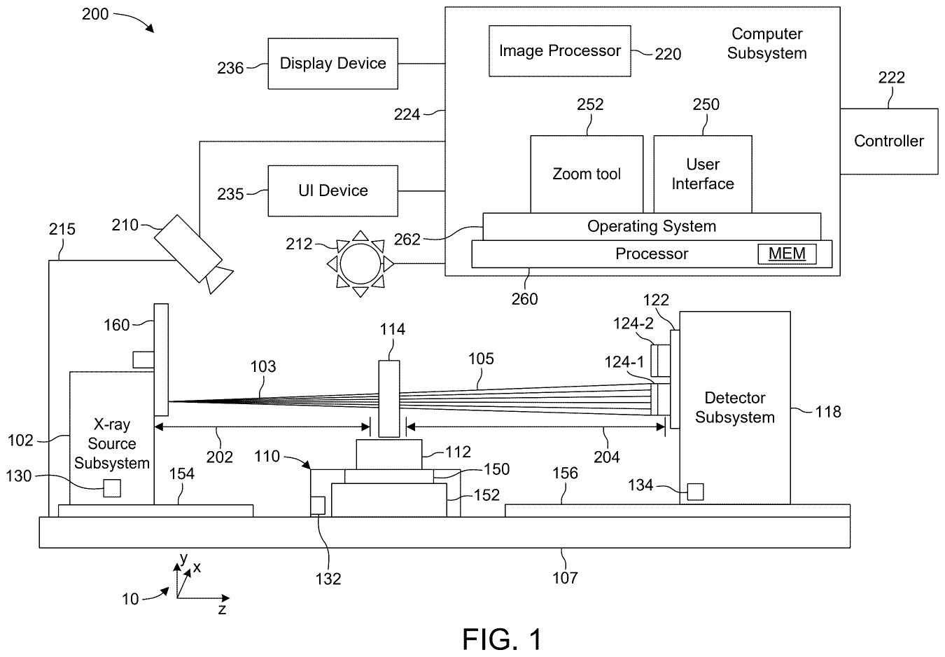

FIG. 1 is a schematic diagram of a XRM system 200 to which the present invention is applicable.

The illustrated microscopy system 200 is an X-ray CT system and generally includes several subsystems. An X-ray source subsystem 102 generates a polychromatic or possibly monochromatic X-ray beam 103. An object stage subsystem 110 with object holder 112 holds a sample or object 114 in the beam and positions and repositions it to enable scanning of the sample 114 in the stationary beam 103, 105. One or more detector subsystems 118 detects the beam 105 after it has been modulated by the sample. A base, such as a platform or optics table 107, provides a stable foundation for the microscopy system 200 and its subsystems. In some examples, there are multiple detector subsystems. One with all the lenses and magnifications going from 0.4× to 40×. The other has a flat panel which is essentially 1×but it typically has a much larger field of view than lenses.

In general, the object stage subsystem 110 has the ability to position and rotate the sample 114 in the beam 103. Thus, the object stage subsystem 110 will typically include linear and rotation stages. The illustrated example has a precision 3-axis stage 150 that translates and positions the sample along the x, y, and z axes, very precisely but only over relatively small ranges of travel. This allows a region of interest of the object 114 to be located within the beam 103/105. The 3-axis stage 150 is mounted on a theta stage 152 that rotates the 3-axis stage 150 and thus sample 114 in the beam around the y-axis. The theta stage 152 is in turn mounted on the base 107.

Thus, the frame of reference or coordinate system of the 3-axis stage 150 is related to the frame of reference or coordinate system 10 of the microscopy system 200 by the angular position of the theta stage 152.

The source subsystem 102 will typically be either a synchrotron x-ray radiation source or alternatively a “laboratory x-ray source” in some embodiments.

As used herein, a “laboratory x-ray source” is any suitable source of x-rays that is not a synchrotron x-ray radiation source. Laboratory x-ray source 102 can be an X-ray tube, in which electrons are accelerated in a vacuum by an electric field and shot into a target piece of metal, with x-rays being emitted as the electrons decelerate in the metal. Typically, such sources produce a continuous spectrum of background x-rays combined with sharp peaks in intensity at certain energies that derive from the characteristic lines of the selected target, depending on the type of metal target used.

In one example, source subsystem 102 is a rotating anode (reflective target) type or micro focused source, with a Tungsten target. Targets that include Molybdenum, Gold, Platinum, Silver or Copper also can be employed. Preferably a transmission-target configuration is used in which the electron beam strikes the thin target from its backside. The x-rays emitted from the other side of the target are used as the beam 103.

The x-ray beam generated by source subsystem 102 is often conditioned to suppress unwanted energies or wavelengths of radiation. For example, undesired wavelengths present in the beam are eliminated or attenuated, using, for instance, energy filters (designed to select a desired x-ray energy range (bandwidth)) held in a filter wheel 160. These energy filters typically include an ‘air’ filter corresponding to no filter along with a set of low energy filters for filtering lower energy x-rays and high energy filters for filtering higher energy x-rays.

When the object 114 is exposed to the X-ray beam 103, the X-ray photons, which propagate through the sample 114, form a modulated beam 105 that is received by the detector subsystem 118. Optionally, an optical magnification stage (containing at least one objective lens) is used to form an image onto the detector subsystem 118 of the microscopy system 200.

Typically, a geometrical and/or optical magnified projection image of the object 114 is formed on the detector subsystem 118. The geometrical magnification of the x-ray stage is equal to the inverse ratio of the source-to-object distance 202 and the source-to-detector distance 204.

To achieve high resolution, an embodiment of the x-ray CT system 200 further utilizes several optical objectives offering different optical magnifications in the optical stage. In one example, the detection system includes a very high resolution detector 124-1. In one example, this high-resolution detector 124-1 has camera, a scintillator, and a microscope objective to provide additional optical magnification in a range between 0.4× and 100×, or more. The scintillator converts the x-rays into an optical image that are magnified by the microscope objective and then detected by the camera.

Other detectors are often included as part of the detector subsystem 118. For example, the detector subsystem 118 can include a lower resolution detector 124-2. This could be a scintillator and flat panel detector or a camera with a lower magnification microscope objective, in examples. Configurations of one, two, or even more detectors 124 of the detector subsystem 118 are possible.

Preferably, the detectors 124-1, 124-2 are mounted on a turret 122 of the detector subsystem 118, so that they can be alternately rotated into the path of the modulated beam 105 from the sample 114.

Typically, the source subsystem 102 and the detector subsystem 118 are mounted on respective z-axis stages. For example, in the illustrated example, the source subsystem 102 is mounted to the base 107 via a source stage 154, and the detector subsystem 118 is mounted to the base 107 via a detector stage 156. In practice, the source stage 154 and the detector stage 156 are lower precision, high travel-range stages that allow the source subsystem 102 and the detector subsystem 118 to be moved into position, often very close to the object during scanning and then be retracted to allow the object to be removed from, a new object to be loaded onto, and/or the object to be repositioned on the object holder 112 of the object stage subsystem 110.

The present microscopy system 200 has an optical camera 210 such as a video camera that collects image data of the sample 114 held in the object holder 112. This camera is typically mounted directly or indirectly to the system base 107 via a mounting system 215, such as a bracket. Typically, optical camera 210 collects the images in the visible portion of the spectrum and/or in the adjacent spectral regions such as the infrared. Usually, the optical camera 210 has a CCD or CMOS image sensor. Also included is a light source 212 that illuminates the object in the spectral regions employed by the optical camera.

The operation of the microscopy system 200 and the scanning of the object 114 is controlled by a computer subsystem 224 that often includes an image processor 220 and a controller 222.

The computer system 224 includes one or more processors 260 along with their data storage resources such as disc or solid-state drives, and memory MEM. The processors 260 execute an operating system 262 and various applications run on that operating system 262 to allow for user control and operation of the microscopy system 200. Particularly, a user interface application 250 executes on the operating system 262 and generates a user interface that is rendered on a display device 236 connected to the computer subsystem 224. The user interface enables the operator to control the system and view projection, images and tomographic reconstructions. User input device(s) 235 such as a touch screen, computer mouse, and/or keyboard enable interaction between the operator and the computer subsystem 224. A zoom tool app 252 generates simulation information for display on the display device 236.

The controller 222 allows the computer subsystem 224 to control and manage components in the X-ray CT microscope 200 under software control. The controller might be a separate computer system adapted to handle real-time operations or an application program executing on the processor 260. The source subsystem 102 includes a control interface 130 allowing for its control and monitoring by the controller 222. Similarly, the object stage subsystem 110 and the detector subsystem 118 have respective control interfaces 132, 134 for allowing for their control and monitoring by the computer subsystem 224 via the controller 222.

To configure the microscopy system 200 to scan the sample and to adjust other parameters such as the geometrical magnification, the operator utilizes the user interface rendered on the display device 236 and generated by the user interface application 250 to adjust the source-to-object distance 202 and the source-to-detector distance 204 by respective operation of the source stage 154 and detector stage 156 to achieve the desired scanning setup.

Specifically, the source stage 154 and detector stage 156 include respective motor encoder systems or other actuator systems that allow the computer system 224 via the controller 222 to position the respective x-ray source subsystem 102 and the detector subsystem 118 to specified positions via the control interfaces 130, 134. Further, the source stage 154 and detector stage 156 signal the controller 222 of their actual positions.

The operator of the system under automatic control operates the object stage subsystem 110 to perform the CT scan via computer subsystem, the controller 222 and the control interfaces 130, 132, 134. Typically, the object stage subsystem 110 will position the object by rotating the object about an axis that is orthogonal to the optical axis of the x-ray beam 103, 105 by controlling the theta stage 152 and/or position the sample in the x, y, z axes directions using stage 150.

Using the user interface rendered on the display device 236 by the user interface app 250, the operator defines/selects scanning set up including the acquisition parameters via the UI devices 235. The source-to-object distance 202 and the source-to-detector distance 204 are often specified and these are converted to the necessary positions or settings for the source stage 154 and detector stage 156 as part of the scanning setup. These acquisition parameters include x-ray source voltage settings that help to determine the X-ray energy spectrum generated by the X-ray source subsystem 102. Other parameters include exposure time and number of frames. The operator also typically selects other settings such as the field of view of the X-ray beam 103 incident upon the sample 114, the number of X-ray projection images to create for the sample 114, and the detector 124-1, 124-2 selected. Generally, the acquisition parameters include X-ray source voltage, X-ray source filtration, camera exposure time, number of frames, and overall number of projections and the scanning setup includes the angles to rotate the sample by the stage subsystem 110.

### Operation:

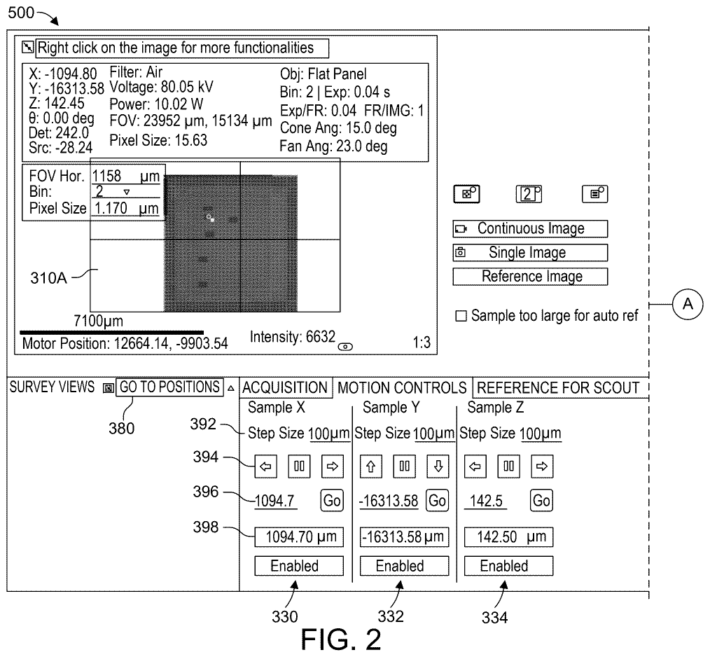

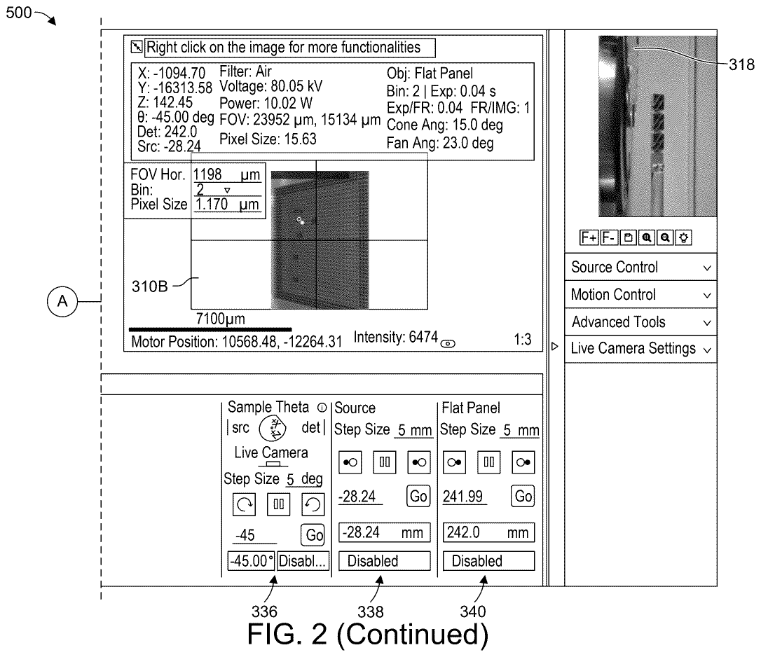

FIG. 2 shows the user interface 500 generated by the user interface app 250 executing on the operating system 262 of the computer system 224 and rendered on the display device 236.

In the illustrated mode, the user interface 500 includes two projection panes 310A, 310B in which overview images are displayed. In the illustrated example, the overview images are projections captured by the detector subsystems 118 for the sample at two different theta angles. In other examples, the overview images can be generated in any number of ways including from: a solid model of the system and VLC imaged sample geometry, a solid model of the sample, volumetric imaging of the sample, projection imaging of the sample, correlated imaging modalities, and/or volumetric imaging of the sample combined with segmentation for automated ROI definition.

The user interface 500 also includes an optical camera pane 318. This displays the current image data received from the optical camera 210. In addition, the user interface 500 includes controls for configuring the X-ray microscopy system 200 to the desired positions for imaging the sample.

Source z-stage control functions 338 are located in the lower right region. This includes a step size indicator indicating the steps that the source stage 154 will move in response to each user input. It includes a current position display. Also included is a user data entry line along with a “Go” button that allows the user to enter a desired absolute position for the source stage 154.

There are similar detector control functions 340 for the detector stage 156 providing Z-axis control functions. Here again, it includes a step size indicator indicating the steps that the source stage will move. Also included is a current position display. Finally, the user can enter a desired absolute position.

Sample motion controls are located at the bottom of the window. A sample x-position control area 330 enables the movement of the object holder 112 and thus the sample or object 114 along the x-axis by control of the x-axis stage of the 3-axis stage 150, a sample y-position control area 332 enables the movement along the y-axis by control of the y-axis stage of the 3-axis stage 150, a sample z-position control area 334 enables the movement along the z-axis by control of the z-axis stage of the 3-axis stage 150, sample theta control area 336 enables the rotation of the object holder 112, 3-axis stage 150, and thus the sample or object 114 by control of the theta stage 152.

Each of the control areas 330, 332, 334, and 336 include separate step size indicators 392. Here, the user can enter the desired step size using the user interface devices. Also included are movement controls 394, back and forward, that allow the decrease or increase of the associated stage. These further include a pause button that will arrest the movement of the corresponding stage. The current position of the corresponding stage is indicated by an absolute location indicator 398. Finally, the user can move to a desired absolute position by entering in the desired position in a data entry line 396 and then selecting the associated “Go” button using the user interface devices 235.

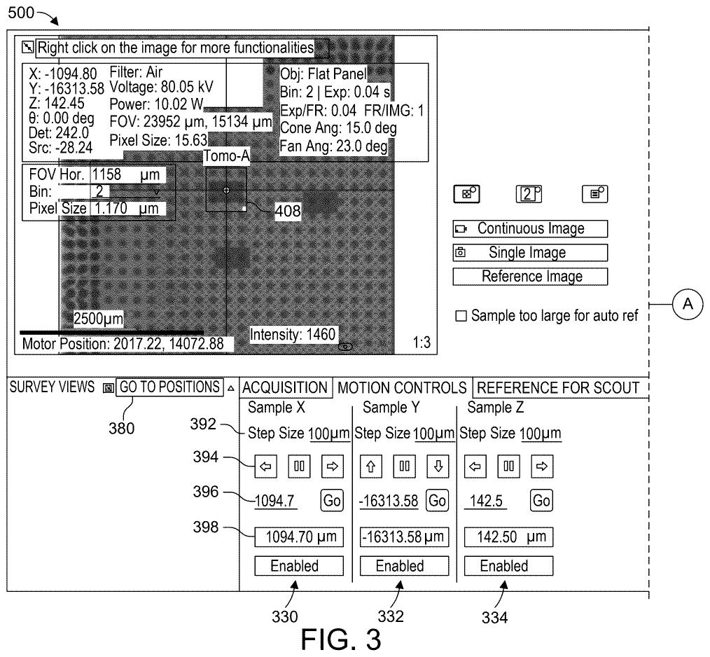

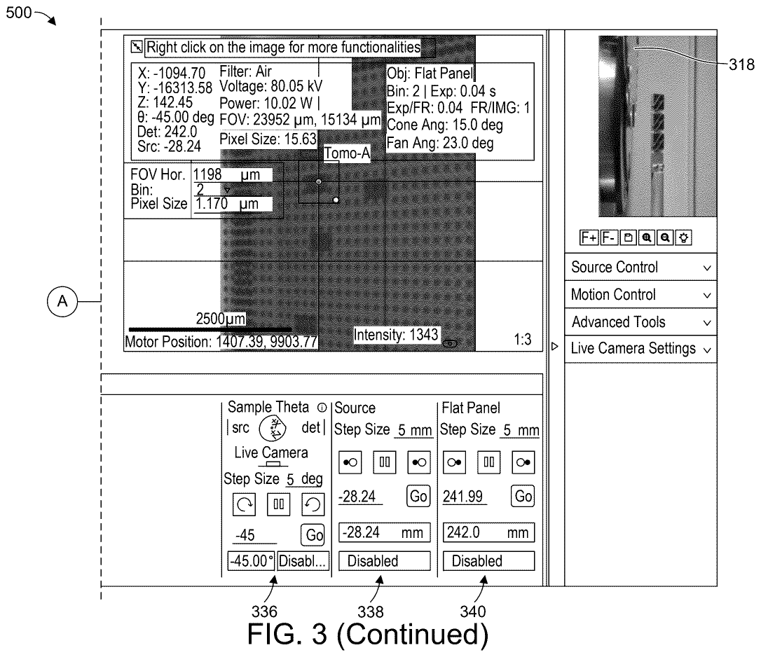

FIG. 3 shows a further mode of the user interface 500 in which the two projection panes 310A, 310B have ROI markers rendered on the overview images. A user movable and sizable ROI marker 408 is used to specify the location and field of view or pixel size desired. This ROI marker is sized and moved by the user via the user interface devices 235. In other examples, the ROI is specified by the non-graphical entry modalities. For example, in these examples, the ROI is specified by the user from a GUI edit box, or from a file or other data interface. In any case, the ROI marker is still rendered in the overview images as a visual confirmation of the ROI.

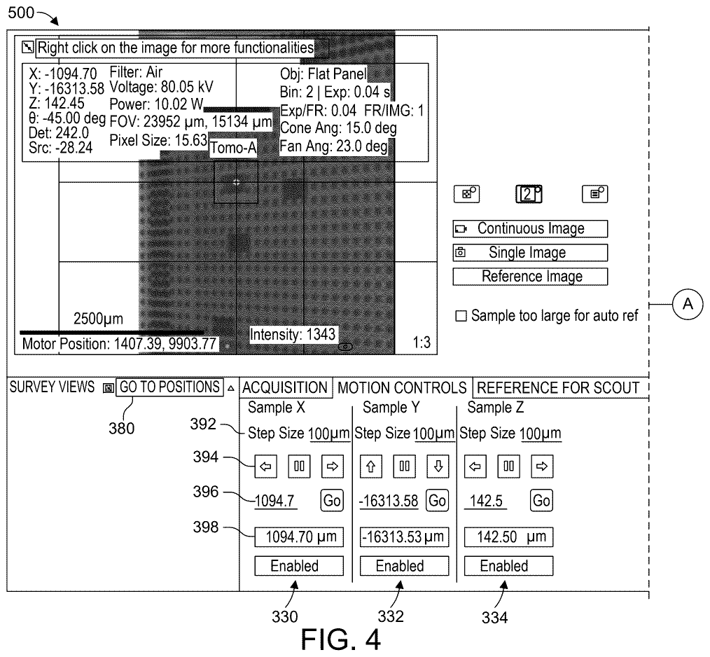

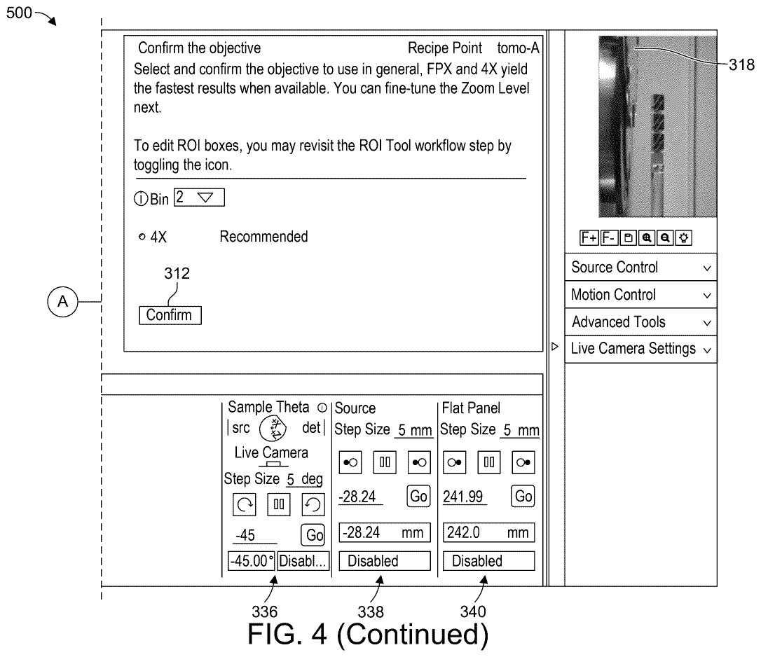

FIG. 4 shows a further mode of the user interface 500 showing the recommended objective(s) that can be used to achieve this field of view at that ROI position. Specifically, one of the projection pane serves as a dialog pane 312 suggesting the use of the 4×objective or many other objectives corresponding to detectors 124-1, 124-2 of FIG. 1 or more and corresponding to the selected ROI.

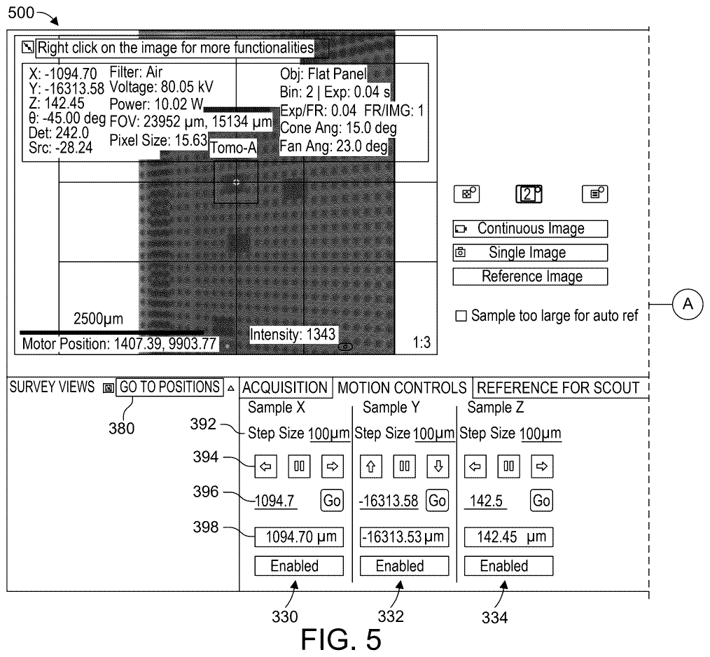

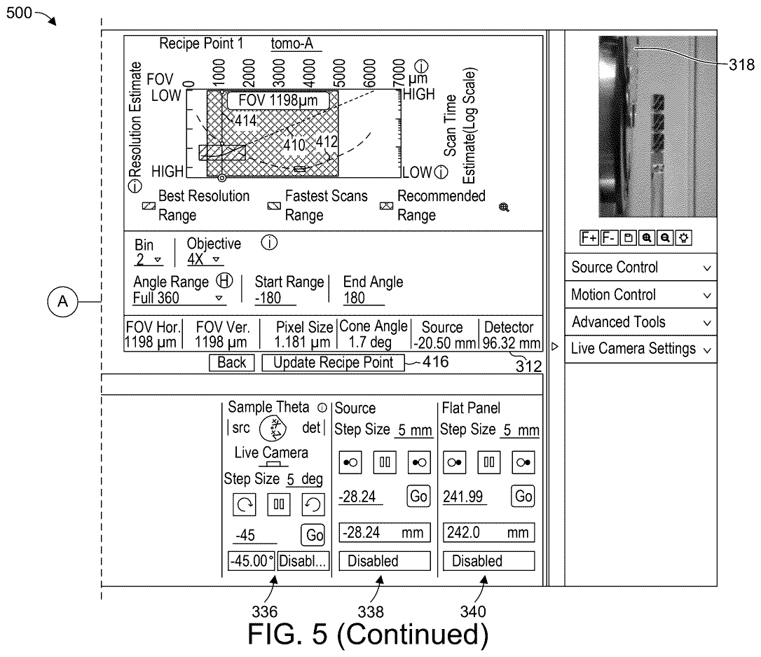

FIG. 5 shows a further mode of the user interface 500 showing the curves for resolution 410 and throughput 412 from a simulation performed by the zoom tool 252 presented in the dialog pane 312.

Also generated by the zoom tool is the exact location on those curves for the requested ROI size 414. The possible operating space curves displayed are already constrained by sample geometry, stage travels, and collision constraints. The dialog pane 312 also only shows the optimal cone angle, source and detector settings at each FOV, ignoring sub-optimal throughput solutions that can achieve similar resolutions at a given FOV but may take longer.

More generally, the zoom tool analyzes cross sectional aspect ratio of the sample envelope and if the aspect ratio is high, meaning it is a flat sample, the tool does calculations based on 180+fan theta range. Otherwise, it just spins the sample typically a full 360 degrees as a default angle range, but the user can select a different range.

When computing, the sample is ‘rotated’ through the angles to make an overall envelope which is used to determine the closest source and detector approach. From that, the tool calculates the ranges of possible FOV, resolution and the relative scan times.

The geometrical magnification settings for the currently selected FOV are based on the sample size and shape (envelope), and calculated such that the selected angle range at this location is collision-free. These curves also show the Recommended Range for optimum results, as well as the Best Resolution Range and Fastest Scan Ranges.

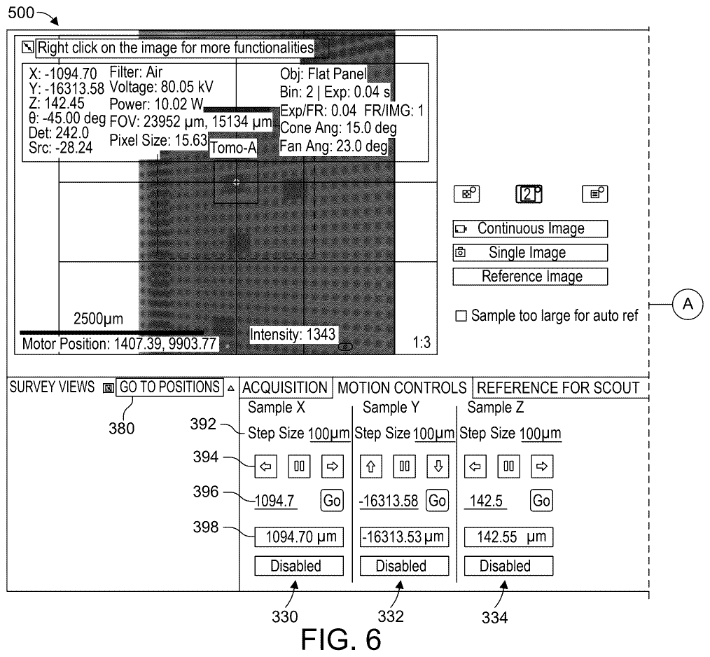

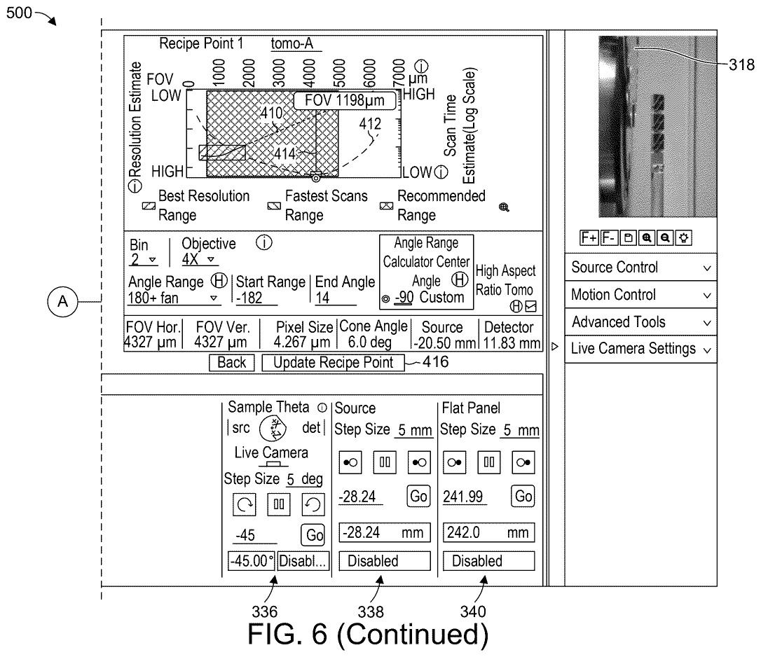

FIG. 6 shows a further mode of the user interface 500 showing the curves for resolution 410 and throughput 412 from a simulation in the dialog pane 312 when the user changes the field of view and pixel size by sliding the bar 414. In this case, the originally requested ROI size was in the Best Resolution Range, but if the user wanted a faster scan, the bar can be moved into the Fastest Scan Range. Note that the size of the white dashed ROI marker changes, as well as the data in dialog pane 312, as the user moves the sliding bar 414.

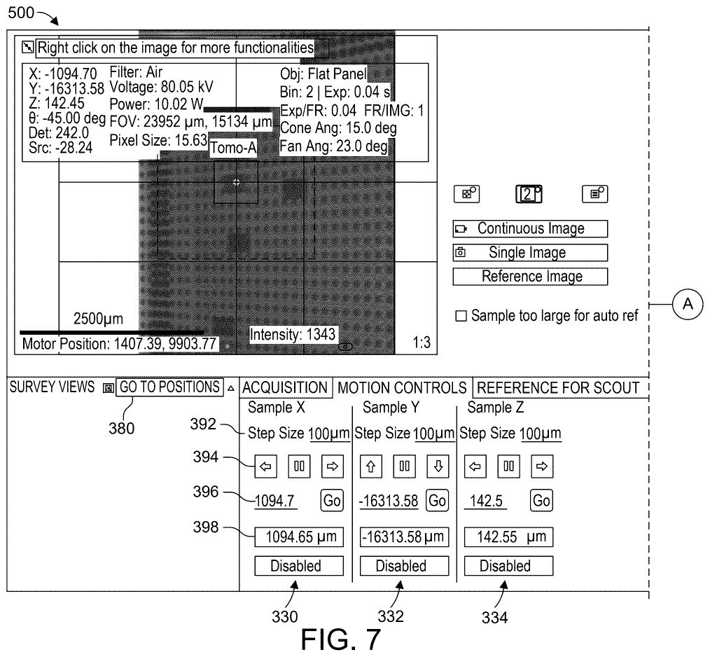

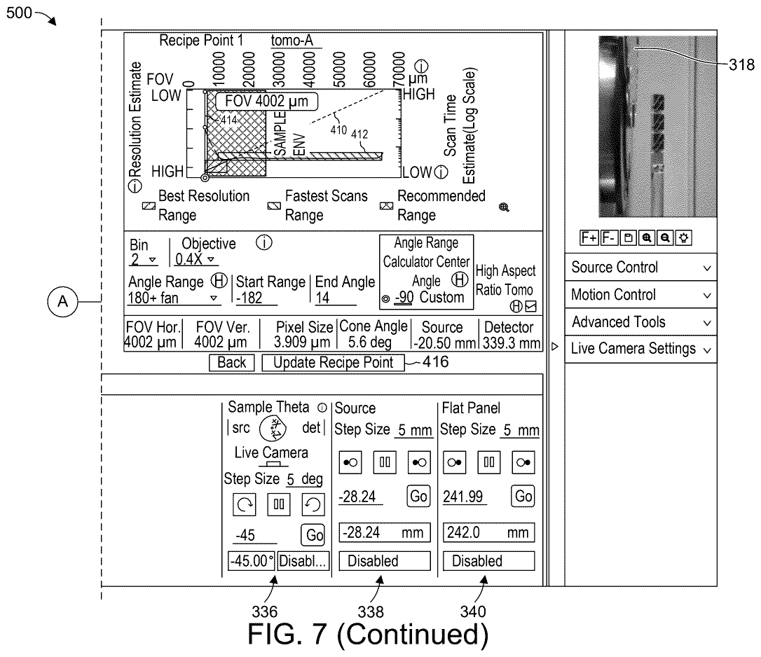

FIG. 7 shows a further mode of the user interface 500 illustrating that the user can also make changes to many settings, such as optical magnification, and new curves for that ROI location and size 414 are generated. In some cases, the originally requested ROI size cannot be preserved with the new optical magnification, which is indicated both visually with the white dashed ROI marker, and with the pixel size and field of view presented in dialogue pane 312. In some cases, there is no “Recommended Range” for a new manually requested optical magnification.

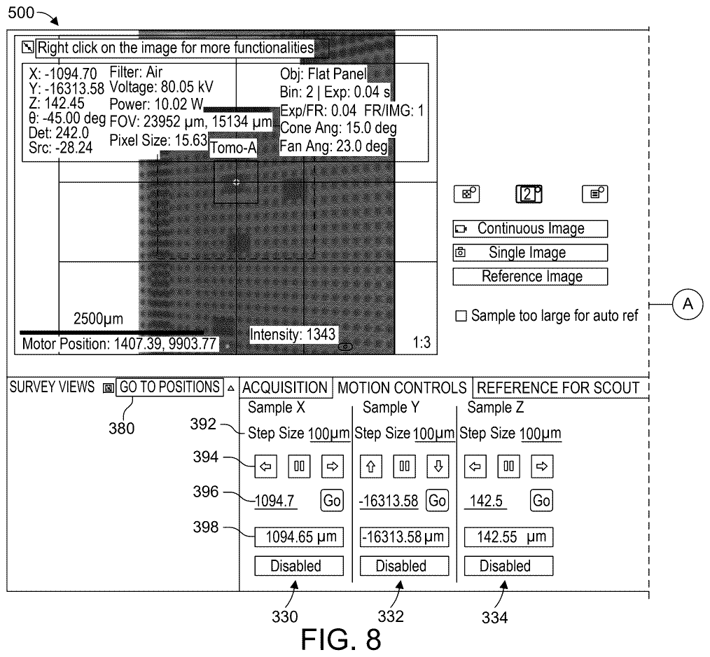

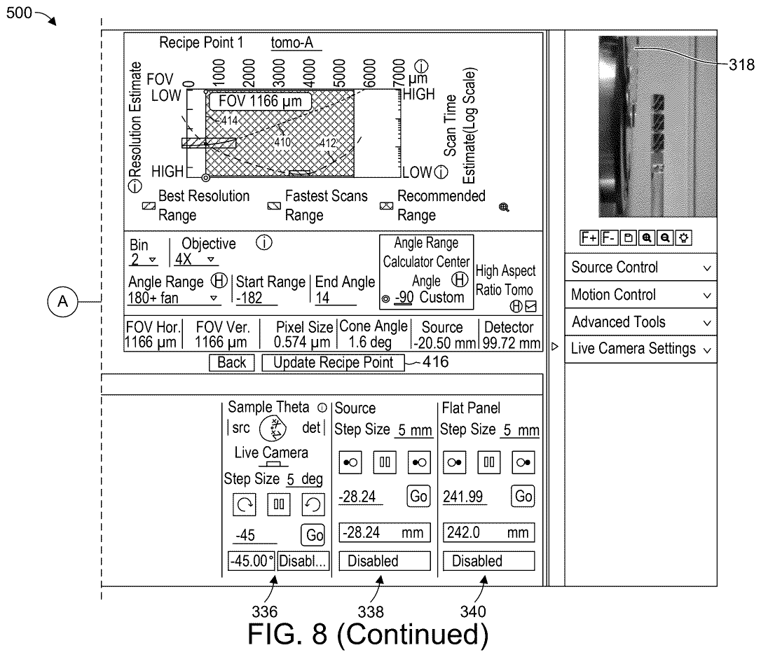

FIG. 8 shows a further mode of the user interface 500 illustrating that the user can also change binning, which creates new simulated curves.

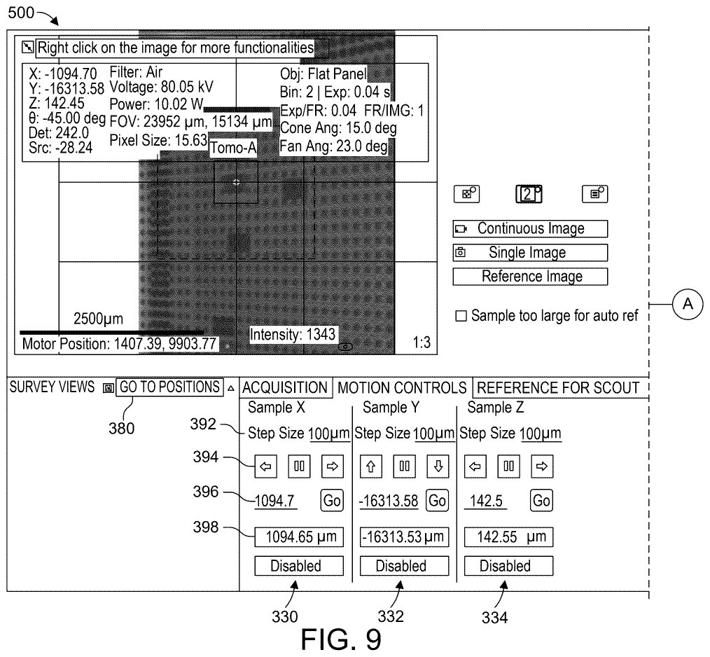

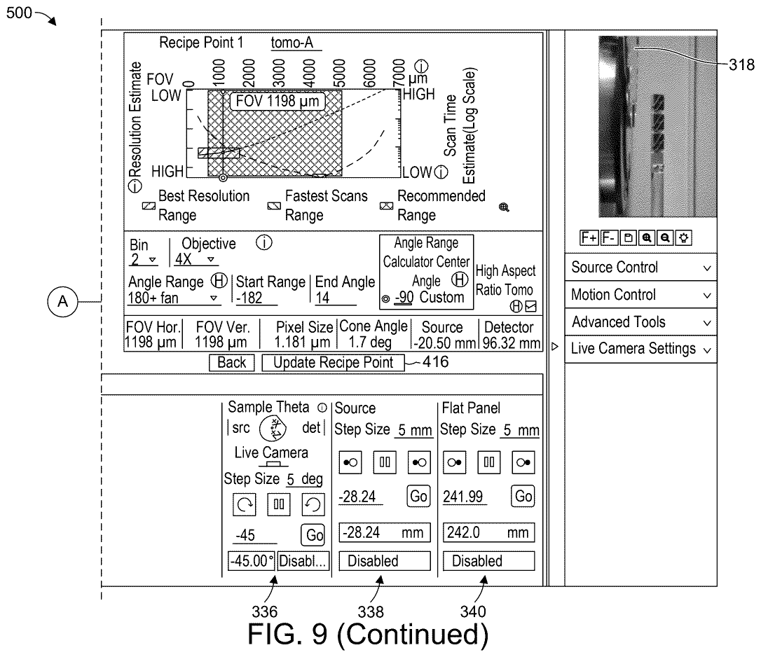

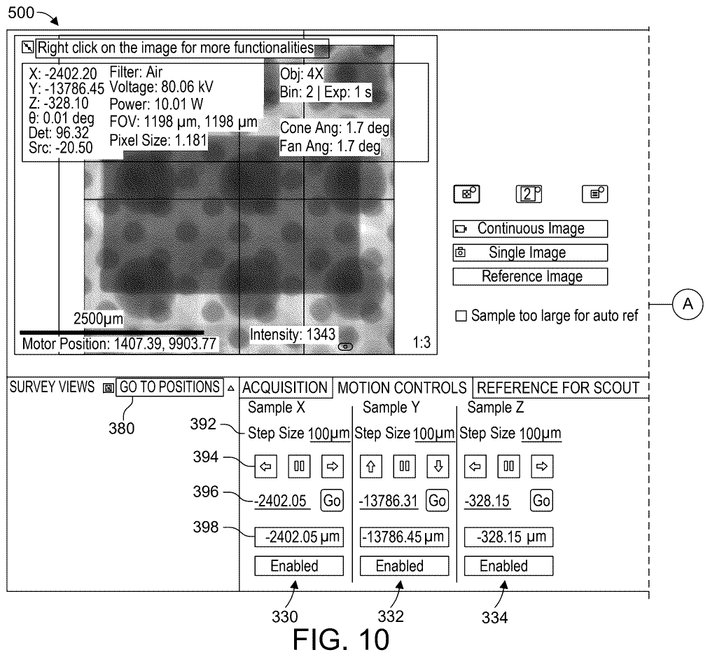

FIG. 9 shows a further mode of the user interface 500, also shown in FIG. 6, illustrating that if the sample has a flat or box shape, advanced acquisition settings for variable angle tomographies and 180+fan range tomographies can also be simulated and optimized using the zoom tool 252.

When finished with the zoom tool, the selected parameters can be saved to the tomography recipe by pressing Update Recipe Point 416.

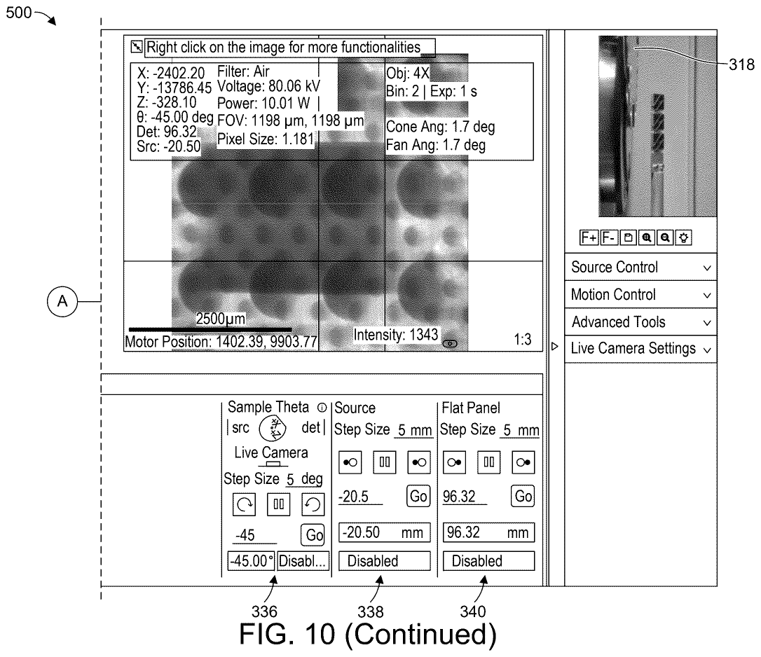

FIG. 10 shows a further mode of the user interface 500 illustrating that the user can then use the tool ‘Go To Positions’ button 380, shown in FIG. 2, to move to the positions selected with the zoom tool, and because the zoom tool simulated curves while knowing the geometrical constraints for the given setup, it is assured that the updated recipe will be collision-free for the full tomography, and the Go To Positions moves are safe for the device and sample. The user can then take images at the new moved to location to verify that the ROI is in the correct location and the field of view and pixel size match what was requested in the zoom tool 252.

For x-ray imaging systems with detector resolution(s) that are comparable to the x-ray source spot sizes, the process to achieve the best resolution is iterative and non-intuitive. In systems with multiple detectors and variable source spot sizes, the ability to get to the fastest scan at a specific resolution is challenging for many users. The ability to rapidly visualize the multi-dimensional solution space and understand the trade-offs between FOV, resolution, and throughput given a particular set of geometric collision constraints and desired FOV selection is non-trivial. Systems that can image a variety of sample sizes and types adds to the confusion. The user will have to locate the source and the detectors to achieve the requisite resolution in the shortest time without colliding the sample with system component during the scan. The present system resolves these issues with an intuitive and interactive graphical interface to illustrate the interactions of the different requirements of FOV, resolution, and scan time while avoiding collision constraints and sub-optimal solutions.

To summarize, the described system can provide several innovations:
The ability to generate the resolution and throughput graphs based on sample and system knowledge and simulations. These include the source spot sizes, the detector pixel sizes and the x-ray and optical responses of these detectors.
Application of geometric constraints (such as collision constraints with sample or between system components or travel limit constraints) to the theoretical solution space to reduce displayed solutions to those that do not violate the constraints.
Algorithmic exclusion of sub-optimal solutions. For example, while there may be many geometric solutions that will yield a certain FOV at a resolution, only the highest throughput of these solutions will be shown.
The knowledge of the closest source and detector approach to the sample based on sample size and shape.
The transfer of the simulated optimal conditions from the graphical interface to parameters used during the scans.
The ability to graphically locate the region of interest within the sample and visualize selected FOV boundary around the region of interest.

At the same time, several capabilities are not always critical. These include:
The suggestions of tomography scanning parameters based on sample shapes. E.g. 180+fan tomography for flat samples.
The initial overview scans.
Numerical displays of projected performance parameters that update with slider position.

It should be further noted that other alternative implementations such as:
The presentation of the graphs may differ. E.g. the horizontal axis does not need to be field of view, it can be pixel size, source/detector positions, geometric magnification, etc., The vertical axes can be detail detectability, MTF, frame rate, etc.,
The method used to input the sample size limitations into the system. E.g., a system generated 3-dimensional collision model is used, but more simplistic methods include user specified sample diameter determined outside of the system.
The specific inputs and algorithms used to simulate the performance parameters displayed on the vertical axes of the graphs may differ. Eg., the resolution can be simulated using geometric methods, empirical look-up tables, etc. The overview images can be generated in any number of ways including from: a solid model of the system and VLC imaged sample geometry, a solid model of the sample, volumetric imaging of the sample, projection imaging of the sample, correlated imaging modalities, and/or volumetric imaging of the sample combined with segmentation for automated ROI definition.

Thus, the present system can facilitate more efficient imaging and avoid the laborious iterative exploration or learning from experience of the imaging parameters to optimize scans to user preferences and the laborious iterative process of moving sample and system components to check for collisions and understand geometric operating space.

While this invention has been particularly shown and described with references to preferred embodiments thereof, it will be understood by those skilled in the art that various changes in form and details may be made therein without departing from the scope of the invention encompassed by the appended claims.

1. A user interface rendered on a display of a microscopy system including a computer that processes projection or image data from the microscopy system, the user interface comprising:
motion controls for moving an object stage subsystem, a source subsystem, and a detector subsystem for configuring the microscopy system to the desired positions for imaging a region of interest of a sample; and
a simulation region showing a resolution curve and a throughput curve for imaging the region of interest of the sample.

2. The user interface as claimed in claim 1, wherein the simulation region further includes region of interest marker showing the region of interest.

3. The user interface as claimed in claim 1, wherein the region of interest is specified by a GUI edit box or from a file or other data interface.

4. The user interface as claimed in claim 1, wherein the region of interest is specified by defining the region of interest on one or more overview images displayed in one or more panes of the user interface, wherein the overview images are derived from models of the system and/or a sample, volumetric imaging of the sample, projection imaging of the sample, correlated imaging modalities, and/or volumetric imaging of the sample combined with segmentation for automated ROI definition.

5. The user interface as claimed in claim 1, wherein the resolution curve and the throughput curve are constrained by sample geometry, stage travel, and collision constraints.

6. The user interface as claimed in claim 1, wherein the resolution curve and the throughput curve are updated in response to user changes to the field of view and/or pixel size.

7. The user interface as claimed in claim 1, wherein the resolution curve and the throughput curve are updated in response to user changes to optical magnification, binning, or angle range.

8. An X-ray microscopy system, comprising:
an X-ray source subsystem of generating X-rays;
an object stage subsystem for holding a sample in the X-rays;
detector subsystems for detecting the X-rays after interaction with the sample; and
a computer for receiving projections from the detector subsystem and generating a user interface including motion controls for moving the object stage subsystem, a source subsystem, and detector subsystems, and a simulation region showing a resolution curve and a throughput curve.

9. (canceled)

10. A method of operation of a microscopy system including a computer that processes projection or image data from the microscopy system, the method comprising:
displaying motion controls for moving an object stage subsystem, a source subsystem, and a detector subsystem for configuring the microscopy system to the desired positions for imaging a region of interest of a sample; and
displaying a simulation region showing a resolution curve and a throughput curve for imaging the region of interest of the sample.

11. The method as claimed in claim 10, wherein the simulation region further includes a region of interest marker showing the region of interest.

12. The method as claimed in claim 10, wherein the region of interest is specified by a GUI edit box or from a file or other data interface.

13. The method as claimed in claim 10, wherein the region of interest is specified by defining the region of interest on one or more overview images displayed in one or more panes of the user interface, wherein the overview images are derived from models of the system and/or a sample, volumetric imaging of the sample, projection imaging of the sample, correlated imaging modalities, and/or volumetric imaging of the sample combined with segmentation for automated ROI definition.

14. The method as claimed in claim 10, further comprising constraining the resolution curve and the throughput curve by sample geometry, stage travel, and collision constraints.

15. The method as claimed in claim 10, further comprising updating the resolution curve and the throughput curve in response to user changes to the field of view and pixel size.

16. The method as claimed in claim 10, further comprising updating the resolution curve and the throughput curve in response to user changes to optical magnification, binning, or angle range.
